(19) United States
(12) Patent Application Publication
(10) Pub. No.: US 2021/0106140 A1
(43) Pub. Date: Apr. 15, 2021

(54) Gaming Chair Lighting Apparatus

(71) Applicant: Gary Platt Manufacturing, LLC, Reno, NV (US)

(72) Inventors: Joshua Corrick, Reno, NV (US); Daniel J. Waller, Reno, NV (US)

(21) Appl. No.: 17/070,637

(22) Filed: Oct. 14, 2020

Related U.S. Application Data
(60) Provisional application No. 62/914,672, filed on Oct. 14, 2019.

(51) Int. Cl. A47C 7/72; F21V 33/00; F21V 23/00; H02J 50/12

(52) U.S. Cl. CPC A47C 7/725; F21V 33/0012; H02J 50/12; A47C 7/727; F21V 23/001

(57) ABSTRACT

A chair power apparatus is disclosed and described herein. An example apparatus includes a first coil separate from a chair, the first coil to receive a first electric current. The example apparatus includes a second coil in the chair to generate a second electric current from a magnetic field formed when the second coil is in proximity to the first coil. The example apparatus includes a circuit in the chair to be powered using the second electric current. An example chair apparatus includes a chair base including a first coil to receive a magnetic field generated by a first electric current applied to a second coil when the second coil is positioned within range of the first coil, the first coil to generate a second electric current from the magnetic field; and a circuit to be powered using the second electric current.

### CROSS-REFERENCE TO RELATED APPLICATIONS

This patent claims priority as a continuation to U.S. Provisional Application Ser. No. 62/914,672 entitled “GAMING CHAIR LIGHTING APPARATUS” which was filed on Oct. 14, 2019, and is hereby incorporated herein by reference in its entirety.

### FIELD OF THE DISCLOSURE

This disclosure relates generally to gaming chairs, and, more particularly, to gaming chairs and associated lighting and charging apparatus.

### BACKGROUND

Power needs are significant in many modern environments. However, it can often be difficult to provide power. Particularly in a high-traffic environment with many parts, such as a casino floor with many chairs, tables, gaming machines, and people, it can be difficult to provide power to devices. Providing power to movable devices is especially difficult. A movable device, such as a chair, may not be able to be tethered to a physical power cable and still be movable or otherwise adjustable in a casino and/or other entertainment environment. Further, providing a battery in such a chair is also impractical, at least because it is difficult and impractical to monitor and replace batteries in chairs in a casino, restaurant, and/or other entertainment environment.

### BRIEF DESCRIPTION OF THE DRAWINGS

FIGS. 1-2 illustrate example electromagnetic power apparatus.

FIGS. 3A-3B illustrate an alternative example electromagnetic power apparatus.

FIG. 4 illustrates an example gaming chair with lighting, sound, and a charging apparatus.

FIG. 5 illustrates an example power system to generate power for devices, subsystems, etc., of the chair of examples 3A-4.

The figures are not to scale. Wherever possible, the same reference numbers will be used throughout the drawing(s) and accompanying written description to refer to the same or like parts.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an example implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects, and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, and (3) at least one A and at least one B.

In addition, it should be understood that references to “one embodiment” or “an embodiment” of the present disclosure are not intended to be interpreted as excluding the existence of additional embodiments that also incorporate the recited features.

Certain examples provide a casino or gaming chair, stool, bench, and/or other seat (hereinafter referred to as a “chair”) that can be separate and/or can be movably positioned with respect to another device such as a gaming machine (e.g., a slot machine, video poker machine, other electronic gaming machine (EGM), etc.), gaming table (e.g., poker table, roulette table, craps table, etc.), bar, counter, etc. For example, the chair allows a user to position themselves with respect to the other device to interact with the other device. In certain examples, the chair can be slidable and/or otherwise positionable with respect to the slot machine, EGM, or other device. For example, the chair can be slidable and/or otherwise positionable along its base to adjust to be closer to or farther from the other device. In certain examples, the base can hook into, be inserted into, snap against, and/or otherwise be positioned in and/or abut the other device. In certain examples, wires and/or other connections can extend from the other device to the chair and be covered and/or otherwise camouflaged by the base of the chair.

The chair includes a chair seat portion, a chair back portion attached to an end of the chair seat portion, and a pedestal, column, or other support member attached at a first end to an underside of the chair seat portion. The pedestal/column can be attached at a second end to a base, slide plate, or column mount (e.g., forming a base portion of the chair). The base/slide plate can be slidable with respect to a footboard or floorplate, which rests on the floor, ground, etc.

In certain examples, the chair is foam-filled (e.g., cold-cured foam blend, other high density molded foam, etc.) for user comfort (e.g., the seat base and/or seat back of the chair can be filled with foam, etc.). In certain examples, the foam is injection molded with built-in lumbar support and other contours to fit the human form. In certain examples, the seat or chair base has a waterfall front edge to relieve stress on a user's legs. In certain examples, the wood is contoured to match the foam to help ensure that neither the wood nor the foam will break down over time. In certain examples, the chair frame incorporates a slider glides that makes the chair easy to move and more user-friendly. In certain examples, a frame of the chair is built with an all-welded construction and designed to stand up to the heavy demands of 24/7 casino use. In certain examples, a base of the chair is an aluminum and/or other metal base.

In certain examples, the chair is coated with a film and/or covered in a liner to provide antimicrobial, antibacterial, and/or other sanitary coating. In certain examples, upholstery of the chair inhibits microbiological growth and is also anti-fungal and anti-mildew to prevent harmful growth or spread of virus, bacteria, etc. Such upholstery can be bleach-cleanable, for example.

In certain examples, the chair can include one or more lights (e.g., light-emitting diode (LED) lights, incandescent lights, low-voltage lights, etc., powered to provide ambience for someone sitting in the chair and/or effects to accompany and/or otherwise enhance a user's game and/or other entertainment experience. The one or more lights can be attuned to game play to change color, motion pattern, etc., based on a state of an associated game or gaming machine, based on ongoing game play, based on a preset mode, based on an event or promotion, etc. The one or more lights can also include ultraviolet light for sterilization, etc. The chair can also include one or more speakers (e.g., low-voltage speakers, etc.), phone/tablet computer charging pad, and/or other electronics, etc., that require power for operation.

Power for lights, speakers, recharging, other chair functions (e.g., motion, vibration, etc.), etc., can be provided through a wired power connection. However, wires can interfere with chair movement/positioning, can get tangled, can be snagged by people, carts, luggage, etc. Wires can break or be bent, which can reduce or eliminate their effectiveness for charging.

Alternatively or in addition to wired power/charging, wireless (e.g., inductive) charging can be used to power chair systems such as lights, sound, charging surface, etc. Inductive charging conveys electricity through an electromagnetic field formed between two coils. As such, energy can be transmitted from a first coil to a second coil using the electromagnetic field. The inductive coupling of coils produces energy across the magnetic field to generate electricity for charging a battery, powering a device, etc.

For example, an induction charger uses a first induction coil or loop to create, when a first electric current (e.g., an alternating current) is applied, an alternating electromagnetic field from within a charging base and a second induction coil or loop to take power from the electromagnetic field and convert the energy back into a second electric current to charge a battery, provide power to a device, etc. In certain examples, a rectifier can convert the second electric current from an alternating current to a direct current. In certain examples, the first electric current can be converted from a direct current to an alternating current to form the magnetic field between the coils. The two induction coils in proximity combine to form an electrical transformer to power light, sound, other charging, etc., in and/or on the chair. In certain examples, greater distances between sender and receiver coils can be achieved when the inductive charging system uses resonant inductive coupling.

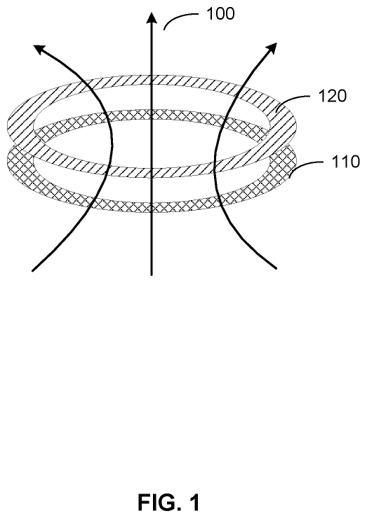

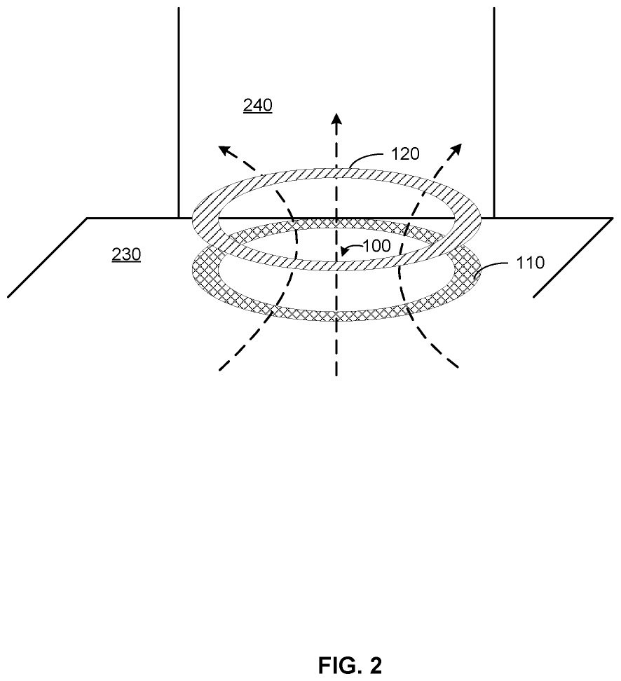

As shown in the example of FIGS. 1-2, an electromagnetic field 100 formed between a) a first coil 110 in a charging element integrated into, placed on top of, and/or positioned underneath a floor, carpet, tile, or substrate 230 and b) a second coil 120 in a base of a chair, stool, couch, and/or other seat 240.

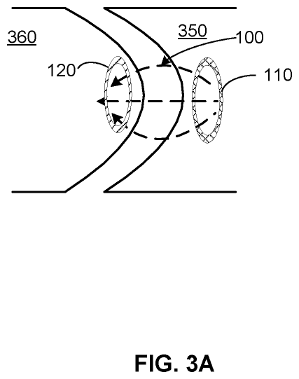

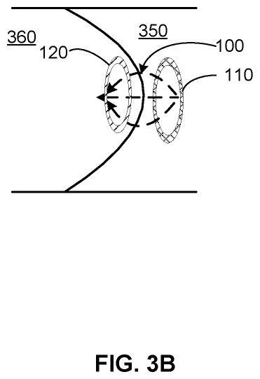

Alternatively or in addition, as shown in the example of FIGS. 3A-3B, the first coil 110 can be placed in a first, non-sliding part of a base 350 and the second coil 120 can be placed in a sliding portion of a chair 360 such that when the chair 360 is slid and/or otherwise moved into a charging position with respect to the non-sliding base 350, an electromagnetic field 100 is formed to facilitate charging of a battery in the sliding portion of the chair 360. As shown in the example of FIG. 3A, when the chair 360 is moved away from the base 350 such that the electromagnetic field 100 cannot be formed, no power or charging ability is provided to the chair 360. However, as shown in FIGS. 3A-3B, when the chair 360 is moved against the base 350 (FIG. 3B) or within range of the base 350 to form the field 100 (FIG. 3A), charge flows to the chair 360 and its systems.

Thus, in certain examples, a base circuit and a receiving circuit each have a loop of wire 110, 120 forming an induction coil. Running a first electric current through the induction coil 110 in the base circuit (e.g., integrated in and/or positioned underneath flooring, carpeting, tile, etc.) generates a magnetic field 100, and, when the induction coil 120 in the receiving circuit (e.g., positioned in a chair bottom, pedestal, leg(s), base, etc.) is positioned within the magnetic field 100, the magnetic field 100 generates a second electric current in the receiver induction coil 120. In certain examples, by vibrating the base induction coil 110 at a same frequency as the receiver induction coil 120 (e.g., forming a resonant coupling, etc.), the magnetic field 100 formed is an oscillating magnetic field that can generate the second electric current in the receiving circuit 120 at a stronger rate and/or at a greater distance than without the vibration. For example, the vibration can be used to generate the magnetic field 100 through tile, carpet, other flooring, etc., to generate the second current in the receiver induction coil 120. Use of a resonant frequency enables the base induction coil 110 and the receiver induction coil 120 to be spaced farther apart, have objects between them, and/or be of different sizes, for example, rather than limiting the induction coils 110, 120 to similar sizes in close proximity, for example. The magnetic field 100 can extend through wood, glass, ceramics, stone (e.g., granite, marble, etc.), human tissue, etc. Metal such as aluminum, steel, etc., will disrupt the magnetic field, for example.

In operation, a magnetic loop antenna 110 (e.g., implemented as a copper coil, a silver-plated copper coil, another metal loop, etc.) creates an oscillating magnetic field 100 when an electric current (e.g., alternating current from a power outlet, generated by interaction with the chair, generated by an associated game or other activity, etc.) is applied to the coil 110. The time-varying magnetic field 100 induces a current in a second closed loop of wire 120 (e.g., a copper coil, a silver-plated copper coil, an aluminum coil, another metal coil or loop, etc.), which serves as a receiver antenna. In certain examples, a capacitance can be applied to introduce resonance in the loops 110, 120 and cause the loops 110, 120 to resonate at the same frequency. The magnetic resonance, also referred to as resonant inductive charging, enables increased current, increases energy transfer efficiency, and increases a distance at which the charging base 230, 350 and chair 240, 360 can be positioned and still have their coils 110, 120 impacted by the magnetic field 100. Coil 110, 120 size also affects the distance of power transfer. For example, the bigger the coil 110, 120 and/or the more coils 110, 120 positioned, the greater the distance a charge can travel. Ultra-thin coils, higher frequencies, etc., can be used to improve distance and/or efficiency of magnetic field 100 generation and electric current transfer, for example. For example, one or more of such strategies can be employed to extend the magnetic field from a few centimeters to several inches to multiple feet, etc.

In certain examples, a size of the magnetic field 100 can be adjusted based on power consumption needs/requirements. Such needs/requirements can be specified in a chair configuration read by a circuit in the chair 240, 360 and/or a circuit in the charging base 230, 350, and/or needs/requirements can be dynamically measured using one or more circuits in the base 230, 350, chair 240, 360, etc. In certain examples, the chair 240, 360 and/or the base 230, 350 and/or associated circuitry can include a temperature sensor that adjusts the magnetic field 100 and, thereby, associated electric current generation to prevent overheating, etc.

Thus, a main input power voltage can be converted to a high frequency alternating current (AC). The AC is relayed to the transmitting coil 110 in the base 230, 350. The AC flowing through the coil 110 creates a magnetic field 100. When the receiving coil 120 of the chair 240, 360 is within range, the magnetic field 110 extends to the receiving coil 120. The magnetic field 100 generates an electric current in the receiving coil 120. The generated current can be used as AC to power sound, light, etc., and/or can be converted to direct current (DC) to charge a battery, power sound, generate light, etc.

In certain examples, user movement of the chair can be used to increase a current applied to the transmitting coil 110 and thereby increase the magnetic field 100 created to generate current in the receiving coil 120. As such, an intensity of light, volume of sound, rate of charging, etc., can be adjusted according to movement. Alternatively or in addition, the chair can be positioned with respect to an electronic gaming machine, and interaction with the gaming machine (e.g., with a game running on the gaming machine, with another sensor, control, actuator, etc., on the gaming machine, etc.) can adjust the current apply to the transmitting coil 110 which adjusts the magnetic field 100 creating a current in the receiving coil 120, for example. As such, more movement/interaction generates more current for faster charging, brighter lights, louder music, faster moving lights, and/or other effect. Less movement/interaction generates less current for slower charging, dimmer lights, quieter music, slower moving lights, and/or other effect.

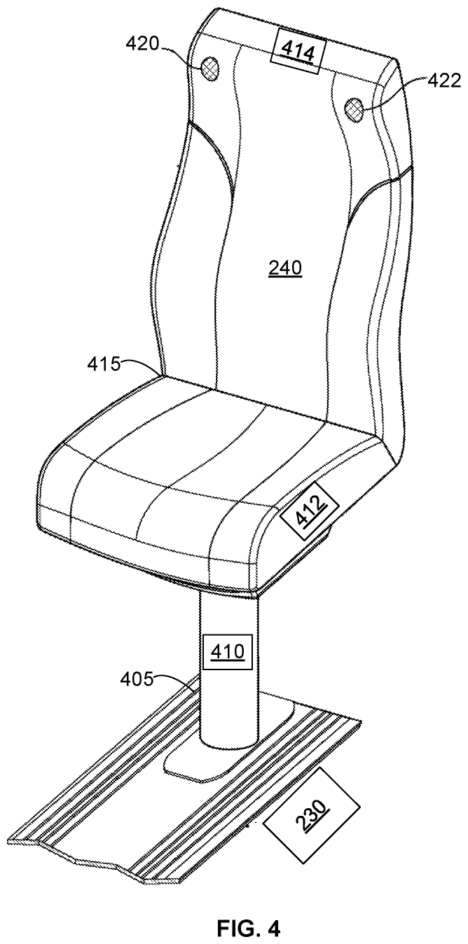

FIG. 4 illustrates an example gaming chair with lighting, sound, and a charging apparatus. As shown in the example of FIG. 4, the chair 240 (and/or 360) includes a base portion that 405 rests on a charging base 230. The base portion 405 of the chair can include a pedestal, column, extension, floor plate, foot board, and/or other support for the chair 240. A seat portion 415 is atop the base portion 405 to accommodate a user. Power provided by inductive charging between the charging base 230 and the chair 240 can be used to power one or more chair lights 410-414, for example. Power can also be used to power one or more chair speakers 420-422, for example. A strength, intensity, duration, and/or other characteristic of the light(s) 410-414, sound 420-422, etc., can depend on a strength of the magnetic field formed between the chair 240 and the charging base 230 to generate current for one or more devices, systems, etc. (e.g., the light(s) 410-414, speaker(s) 420-422, a charging pad, etc.) in the chair 240. In certain examples, the base portion 405 of the chair 240 can include a battery to store the generated power for use by the light(s) 410-414, speaker(s) 420-422, etc. The base portion 405 of the chair 240 includes means for forming a magnetic field based on application of a first electric current; and means for providing a second electric current generated by the magnetic field to power a device such as the light(s) 410-414, speaker(s) 420-422, battery, charging pad, etc., in the chair 240.

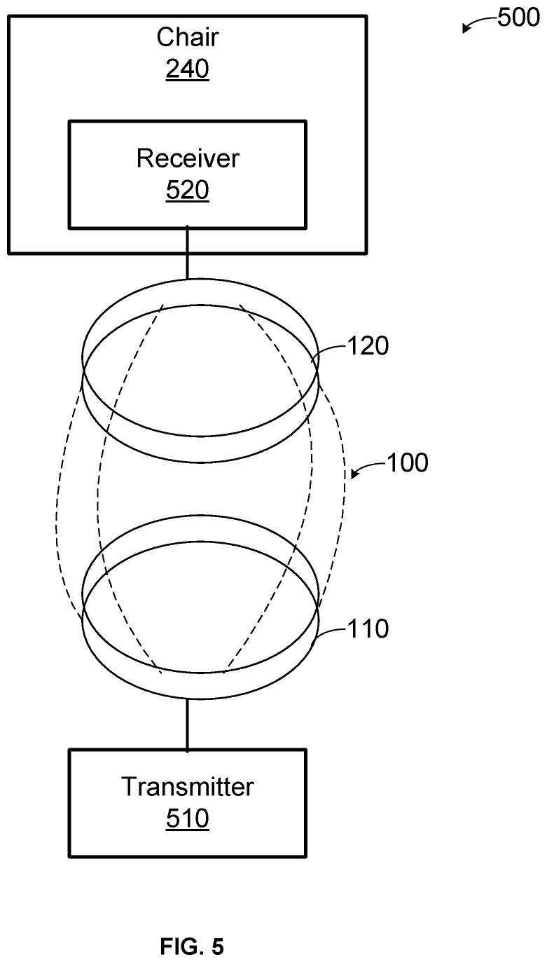

FIG. 5 illustrates an example power system 500 to generate power for devices, subsystems, etc., of the chair 240, 360 such as the lights 410-414, speakers 420-422, a charging pad for a phone, etc. The example of FIG. 5 depicts a transmitter 510 coupled to one or more loops of the base or transmitter induction coil 110 and a receiver 520 coupled to one or more loops of the receiver induction coil 120. The receiver 520 is also coupled to the chair 240, 360 (e.g., incorporated into the chair 240, 360) and connected to chair subsystems/devices such as the lights 410-414, speakers 420-422, etc. As described above, proximity of the coils 110, 120 through cloth, tile, plastic, etc., generates the magnetic field 100 when a charge is introduced to the transmitter coil(s) 110 via the transmitter circuit 510. The excitation of electrons in the receiver coil(s) 120 generates a current at the receiver circuit 520 that can be used to power various chair 240, 360 systems such as light(s) 410-414, speaker(s) 420-422, charging pad, chair positioning mechanism(s) (e.g., recline, shift, adjust, etc.), etc. The receiver circuit 520 can include a rectifier to generate direct current from the induced alternating current, for example. The receiver circuit 520 can include a battery to be charged by the current, for example. The receiver circuit 520 can include a switch to route electricity to one or more chair 240, 360 devices/subsystems, for example. In certain examples, the switch is configured according to a prioritization to first allocate power to a first chair system and next allocate power to a second chair system, etc. As such, the switch of the example receiver 520 can be configured to first allocate power to the light(s) 410-414, next allocate power to the speaker(s) 420-422, etc. Thus, subsystems, devices, etc., within the chair 240, 360 can be prioritized to receive power, and total power distribution may depend on a user's activity and/or mode delivering more or less power to the chair 240, 360 through the coils 110, 120 and associated transmitter 510/receiver 520 circuitry. When a current and/or other stimulus is not applied at the transmitter 510, no field 100 is generated and no current is provided at the receiver 520.

As such, a process to dynamically provide inductive power to a chair includes introducing a first current at the transmitter 510 to introduce a charge to the transmitter coil 110. Interaction between the transmitter coil 110 and the receiver coil 120 caused by the charge forms a magnetic field 100 between the coils 110, 120 (e.g., through material and flooring such as carpet, tile, upholstery, fabric, stone, wood, etc.). The field 100 generates a second current at the receiver 520, which can then be provided to one or more components in the chair 240, 360. An increase in the first current increases the field 100, which causes an increase in the second current, for example. Correspondingly, a decrease in the first current decreases the field 100, which causes a decrease in the second current, for example. Adjustment to the first current of the transmitter 510 and/or other influence on the magnetic field 100 between the coils 110, 120 results in an adjustment to the second current made available at the receiver 520 to power chair 240, 360 component(s), for example.

In certain examples, the coil 120 provides means for forming a magnetic field based on application of a first electric current. In certain examples, the combination of coils 110, 120 provides means for forming a magnetic field based on application of a first electric current. In certain examples, the receiver 520 provides means for providing a second electric current generated by the magnetic field to power a device.

From the foregoing, it is appreciated that the above disclosed methods, apparatus, and articles of manufacture have been disclosed to provide a new, improved power mechanism for a chair. The improved power mechanism generates and provides power to one or more devices in the chair based on a position of the chair. Certain examples provide power through an electromagnetic field formed between a) a first coil in a charging element integrated into, placed on top of, and/or positioned underneath a floor and b) a second coil in a base of a chair. Alternatively or in addition, a first coil can be placed in a first, non-sliding part of a base, and a second coil can be placed in a sliding portion of a chair such that when the chair is slid and/or otherwise moved into a charging position with respect to the non-sliding base, an electromagnetic field is formed to facilitate charging of a battery in the sliding portion of the chair.

Further aspects of the invention are provided by the subject matter of the following clauses.

Example 1 includes a chair power apparatus. The example apparatus includes a first coil separate from a chair, the first coil to receive a first electric current. The example apparatus includes a second coil in the chair to generate a second electric current from a magnetic field formed when the second coil is in proximity to the first coil. The example apparatus includes a circuit in the chair to be powered using the second electric current.

Example 2 includes an example chair apparatus. The example chair apparatus includes a chair base including a first coil to receive a magnetic field generated by a first electric current applied to a second coil when the second coil is positioned within range of the first coil, the first coil to generate a second electric current from the magnetic field; and a circuit to be powered using the second electric current.

Example 3 includes a chair. The example chair includes a seat portion; and a base portion. The example base portion includes: means for forming a magnetic field based on application of a first electric current; and means for providing a second electric current generated by the magnetic field to power a device.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A chair power apparatus comprising:
a first coil separate from a chair, the first coil to receive a first electric current;
a second coil in the chair to generate a second electric current from a magnetic field formed when the second coil is in proximity to the first coil; and
a circuit in the chair to be powered using the second electric current.

2. The chair power apparatus of claim 1, further including a transmitter attached to the first coil to apply the first electric current to the first coil.

3. The chair power apparatus of claim 1, further including a receiver attached to the second coil to provide the second electric current to the circuit.

4. The chair power apparatus of claim 1, wherein the circuit is connected to a light in the chair.

5. The chair power apparatus of claim 1, wherein the circuit is connected to a speaker in the chair.

6. The chair power apparatus of claim 1, wherein the circuit is connected to a charger in the chair.

7. The chair power apparatus of claim 1, wherein the receiver includes a rectifier to convert the second electric current from an alternating current to a direct current.

8. The chair power apparatus of claim 1, wherein the first coil is positioned in a charging base.

9. The chair power apparatus of claim 8, wherein the second coil is positioned in a base of the chair, the chair movable at the base to nest with the charging base and move away from the charging base.

10. The chair power apparatus of claim 1, wherein the first electric current is influenced by at least one of i) movement of the chair or ii) activity associated with a gaming machine attached to the chair.

11. A chair apparatus comprising:
a chair base including a first coil to receive a magnetic field generated by a first electric current applied to a second coil when the second coil is positioned within range of the first coil, the first coil to generate a second electric current from the magnetic field; and
a circuit to be powered using the second electric current.

12. The chair apparatus of claim 11, further including a receiver attached to the first coil to provide the second electric current to the circuit.

13. The chair apparatus of claim 12, wherein the receiver includes a rectifier to convert the second electric current from an alternating current to a direct current for the circuit.

14. The chair apparatus of claim 11, further including a light, and wherein the circuit is connected to power the light.

15. The chair apparatus of claim 11, further including a speaker, and wherein the circuit is connected to power the speaker.

16. The chair apparatus of claim 11, further including a charger, and wherein the circuit is connected to power the charger.

17. The chair apparatus of claim 11, wherein the chair base is movable with respect to a charging base including the second coil, and wherein the chair base is movable to nest with the charging base to generate the magnetic field for the second electric current and to separate from the charging base to remove the magnetic field and stop generation of the second electric current.

18. The chair apparatus of claim 11, wherein the first electric current is influenced by at least one of i) movement of the chair apparatus or ii) activity associated with a gaming device attached to the chair apparatus.

19. A chair comprising:
a seat portion; and
a base portion, the base portion including:
means for forming a magnetic field based on application of a first electric current; and
means for providing a second electric current generated by the magnetic field to power a device.

20. The chair of claim 19, wherein the device includes at least one of a light or a speaker in the chair.
